(19) United States
(12) Patent Application Publication
(10) Pub. No.: US 2003/0094430 A1
(43) Pub. Date: May 22, 2003

(54) Traversing twist cap

(76) Inventors: Gene Stull, Far Hills, NJ (US); Robert T. Auer, East Stroudsburg, PA (US)

Correspondence Address: Shahan Islam, Rosenman & Colin LLP, 575 Madison Avenue, New York, NY, 10022-2585, US

(21) Appl. No.: 09/875,430

(22) Filed: Jun. 5, 2001

Related U.S. Application Data
(60) Provisional application No. 60/209,728, filed on Jun. 5, 2000.

(51) Int. Cl. B67D 5/06; B65D 41/04

(52) U.S. Cl. 215/321; 222/520; 222/525; 222/549

(57) ABSTRACT

There is provided according to the present invention, a rotary valve cap and container comprising a cap portion having an inner sidewall with guide bosses disposed thereon and a sealing skirt disposed from the top of the cap concentric with the inner sidewall, and a container neck portion having an inner and an outer sidewall, wherein the outer sidewall has an undulating bead thereon, such that said guide bosses engage said undulating bead for raising and lowering said cap such that said sealing skirt is sealably engages said container neck.

### RELATED APPLICATIONS

This application claims priority of Provisional No. 60/209,728, filed on Jun. 5, 2000, which is incorporated herein by reference in its entirety.

### BACKGROUND OF INVENTION

1. Field of the Invention

This invention relates to a resealable rotary dispensing cap which is particularly well suited for dispensing liquids and particulate matter and method of making and using same.

2. Brief Statement Of The Prior Art

The term “container” as used herein and in the claims, is to be interpreted as being inclusive of glass or plastic bottles, metallic cans, jars, cups, bottles and the like.

The term “cap” as used herein and in the claims, is to be interpreted as being inclusive of a cap closure such as a snap fit, push-pull, twist open, or the like, used for providing a closure over a container as described above.

Plastic dispensing caps for containers such as plastic and glass bottles and plastic tubes are well established products with many years of development and commercial use. A problem which has not been satisfactorily resolved by the prior art designs is to provide a one piece resealable dispensing cap that can be manufactured by forming parts having a simple design which can be used with equal effectiveness for dispensing liquids and particulate matter, having adequate seals to prevent leakage of contents of the container, without the need for intricately shaped parts that are difficult and expensive to manufacture.

A need therefore exists and it is an object of this invention to provide a resealable dispensing cap.

It is another object of this invention to provide a resealable dispensing cap, which is particularly well suited for dispensing liquids and particulate matter.

It is yet another object of this invention to provide a resealable dispensing cap that can be opened and closed by rotating the cap about its axis to provide an infinitely variable spout opening between the fully opened and closed limits.

It is yet another object of this invention to provide a resealable dispensing cap that can be opened and closed by rotating the cap about its axis having a spout opening that is free from obstruction or flow restriction.

It is yet another object of this invention to provide a resealable dispensing cap having a simple design without intricate parts that provides adequate sealing of the contents.

It is yet another object of this invention to provide a resealable dispensing cap wherein the sealing housing is permanently affixed to the container neck.

It is yet another object of this invention to provide a resealable dispensing cap wherein the sealing housing provides detents to provide ease of use.

Other objects, features, and advantages of the present invention will become apparent from the following detailed description, the accompanying drawings, and the appended claims.

### SUMMARY OF THE INVENTION

To meet the above expressed needs and objects, this invention provides a one-piece injection molded rotary cap that can be turned about its axis in either direction, to open or close the nozzle channel. The cap skirt is designed to snap over an undulating convex/concave bead. Located on the inside of the cap skirt walls are two sets of snaps that are located 180 degrees directly opposite each other. Both sets of snaps fit over and under the container bead. The 360-degree continuous undulated bead is molded with two parallel off setting segments that are of equal distance up and down, top and bottom. The continuous bead or track is molded in one consistent thickness. In an exemplary embodiment of the present invention, the two valleys and two peaks on the bead track are 180 degrees opposite each other. When the cap is turned it automatically opens and closes the dispensing track by following the up and down fluctuations on the bead track. The inner sealing ring opens and closes as the cap moves up and down, causing the inner ring to slide in and out of the inner wall of the container neck. Dispensing product is done by turning the cap to an open position, tipping the container on its side or upside down and applying pressure to the sidewalls of the container, thereby decreasing the volume of the container and increasing the pressure inside the container to force product through the opening.

Therefore, there is provided according to the present invention, A rotary valve cap and container comprising a cap portion having an inner sidewall with guide bosses disposed thereon and a sealing skirt disposed from the top of the cap concentric with the inner sidewall, and a container neck portion having an inner and an outer sidewall, wherein the outer sidewall has an undulating bead thereon,

such that said guide bosses engage said undulating bead for raising and lowering said cap such that said sealing skirt is sealably engages said container neck.

### DESCRIPTION OF THE DRAWINGS

The invention will be described with reference to the figures of which:

FIG. 1a is an elevational cross section view of the rotary valve cap of the invention in an open position on a container neck;

FIG. 1b is an elevational cross section view of the rotary valve cap of the invention in a closed position on a container neck;

FIG. 1c is elevational view of the rotary valve cap of the invention;

FIG. 1d is an overhead plan view of the rotary valve cap of the invention;

### DESCRIPTION OF THE PREFERRED EMBODIMENT

As will be appreciated, the resealable rotary dispensing cap can be of other configurations consistent with the descriptions herein. Therefore the device of the present invention, while not limited thereto, has for purposes of illustration and description been presented to conform to the drawings attached hereto.

In accordance with the present invention, a rotary valve cap is used for closing and sealing a bottle, or other container, having a neck including a lip surrounding the pouring opening. The neck of the container has thereon an undulating bead for raising and lowering the cap. The undulating bead is continuously disposed about the outer diameter of the container neck and having two concave portions and two convex portions each portion separated by a point of inflection. The peak of each convex portion is disposed about the container neck at a point that is separated by 90 degrees from the valley of each concave portion.

The rotary valve cap is adapted to fit over the neck of the container. The cap has a nozzle or opening for allowing product to flow from the container disposed on the sidewall of the rotary valve cap. On the outer surface, there are two finger detents to provide easy of gripping. Alternately, one skilled in the art could see that the detents could be replaced or modified to provide other means of grip assistance. On the inner surface of the container, there is a sealing skirt member disposed concentrically inside the cap sidewall from the top of the cap cover extending down. On the inner sidewall of the cap there are located guide bosses adapted to fit over the undulating bead that lock the cap in place on the container neck. There are provided two pairs of upper and lower guide bosses. The lower guide bosses are disposed such that they engage the lower edge of the undulating bead, while the upper guide bosses are disposed such that they engage the upper edge of the undulating bead. Each pair of upper and lower guide bosses are located on the inner sidewall at points separated by 180 degrees, such that each pair of guide bosses rides on the corresponding opposite portion of the undulating bead. For example, when one pair of guide bosses is riding on the peak of one convex portion the second pair of guide bosses in riding on the peak of the other convex portion. The guide bosses of the rotary valve cap fit over the undulating bead such that as the cap is rotated the guide bosses ride on the bead to raise and lower the cap.

The annular sealing skirt is disposed from the top of the inside surface of the cap and extends down from the cap top, engaging the inside of the container neck. The outer diameter of the sealing skirt bears against the inner diameter of the container neck, thereby forming a seal. The sealing skirt walls extend down from the top of the cap such that there are two long skirt wall portions and two short skirt wall portions, each separated by 90 degrees. The short skirt wall portions are located in alignment with the guide bosses such that then the guide bosses ride on the two peaks of the undulating bead, the short sealing skirt wall disengages from the container neck, thereby providing a passage for the product to flow out of the nozzle. One skilled in the art can see that the sealing skirt can be modified such that the short portion has a circumference that is greater or less that 90 degrees about the axis of the cap, thereby providing a larger or smaller product passage. Likewise the undulating bead can also be modified to have only one peak and thus only one open position, or more than two peaks and thus more than two open positions.

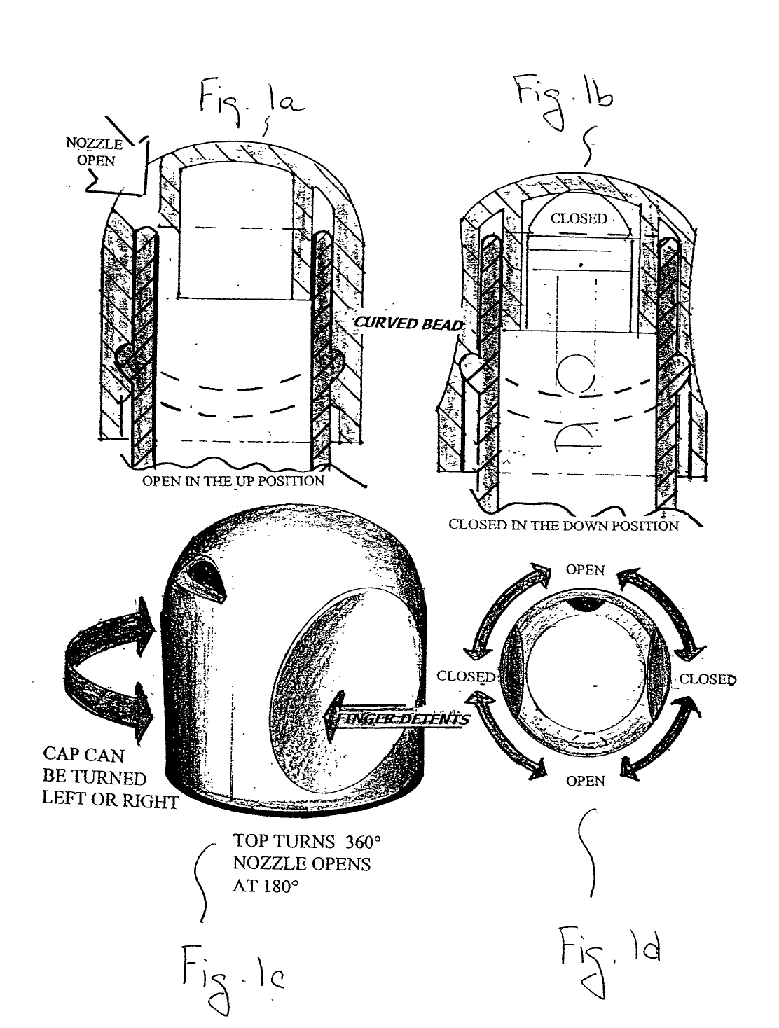

Turning to FIG. 1a, there is shown a cross sectional view of the rotary valve cap in an open position, having sidewalls, upper and lower guide beads, a nozzle and a sealing skirt, that is in cooperative engagement with the container neck. Disposed on the outer diameter of the container neck is an undulating bead in engagement with the cap guide bosses. In the open position the sealing skirt is disengaged from the container neck, thereby creating an opening for product flow.

Turning to FIG. 1b, there is shown a cross sectional view of the rotary valve cap in an closed position, having sidewalls, upper and lower guide beads, a nozzle and a sealing skirt, that is in cooperative engagement with the container neck. Disposed on the outer diameter of the container neck is an undulating bead in engagement with the cap guide bosses. In the closed position shown in FIG. 1b the sealing skirt is engaged from the container neck, thereby creating sealing the container.

Turning to FIG. 1c, there is shown an elevational view of the rotary valve cap, having a nozzle or opening for product flow when in the open position and finger detents to aid in gripping the cap.

Turning to FIG. 1d, there is shown a cross sectional plan view of the rotary cap indicating both open and closed positions, wherein the open and closed positions are separated by 90 degrees of rotation about the axis of the cap. When the cap is rotated it raises and lowers thereby alternately engaging and disengaging the sealing skirt and the container neck and opening and closing the container.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A rotary valve cap and container comprising:
a cap portion having an inner sidewall with guide bosses disposed thereon and a sealing skirt disposed from the top of the cap concentric with said inner sidewall,
a container neck portion having an inner and an outer sidewall, wherein said outer sidewall has an undulating bead thereon, such that said guide bosses engage said undulating bead for raising and lowering said cap, such that said sealing skirt is sealably engages said container neck.
